(19) United States
(12) Patent Application Publication
(10) Pub. No.: US 2026/0252126 A1
(43) Pub. Date: Aug. 27, 2026

(54) MOVING BODY CONTROL SYSTEM, MOVING BODY CONTROL METHOD, LEADER MOVING BODY, LEADER MOVING BODY CONTROL METHOD, FOLLOWER MOVING BODY, FOLLOWER MOVING BODY CONTROL METHOD, AND RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/159,385

(22) PCT Filed: Mar. 9, 2023
(86) PCT No.: PCT/JP2023/009050

§ 371 Date: Aug. 25, 2025

(51) Int. Cl. G05D 1/698; B63G 8/00; G05D 109/30; G05D 111/30

(52) U.S. Cl. CPC G05D 1/6985; B63G 8/001; B63G 2008/002; G05D 2109/38; G05D 2111/32

(57) ABSTRACT

Moving body control system 30 is a moving body control system including a leader moving body 40 and a follower moving body 50. The leader moving body 40 includes a leader preliminary agreement unit 41 that shares an agreement item, which is an item agreed upon regarding a method by which the leader moving body 40 and the follower moving body 50 merge, with the follower moving body 50 prior to merging, and a leader movement control unit 42 that controls movement of the leader moving body 40 based on the shared agreement item. The follower moving body 50 includes a follower preliminary agreement unit 51 that shares the agreement item with the leader moving body 40 prior to merging, and a follower movement control unit 52 that controls movement of the follower moving body 50 based on the shared agreement item.

### TECHNICAL FIELD

The present disclosure relates to a moving body control system, a moving body control method, a leader moving body, a leader moving body control method, a follower moving body, a follower moving body control method, and a recording medium. More specifically, it relates to a moving body control system, a moving body control method, a leader moving body, a leader moving body control method, a follower moving body, a follower moving body control method, and a recording medium for enabling a plurality of moving bodies to merge and move together.

### BACKGROUND ART

A control method in which a small number of moving bodies that serve as leaders (hereinafter referred to as “leader moving bodies” or simply “leaders”) cause a large number of moving bodies that serve as followers (hereinafter referred to as “follower moving bodies” or simply “followers”) to follow is called leader-follower control. A moving body is, for example, a robot.

The advantage of leader-follower control is that when the performance of a small number of leaders is high, the followers can compensate for their lower performance by acting based on instructions from the leaders. By using a leader-follower control mechanism, the manager of the moving bodies can reduce costs and so on because it is sufficient to enhance the performance of only some of the moving bodies, rather than all of them.

In order for leader-follower control to be executed, it is required that the leaders and followers form a formation.

Non patent literature 1 discloses a method in which a follower moving body dives into the sea, turns and waits after diving, and then starts following and sailing behind a leader moving body when the formation sailing start time is reached. Non patent literature 1 also describes an example in which three moving bodies form a formation.

Furthermore, non patent literature 2 discloses an example in which only bearings are tracked using an extended Kalman filter composed of a Cartesian coordinate system and a modified polar coordinate system.

### CITATION LIST

### Non Patent Literature

NPL 1: National Maritime Research Institute, “Stabilization of Seafloor Mineral Resource Survey by Formation Control of Navigational AUVs,” FY2020 Research Presentation, Poster Session 10, Jul. 28-29, 2020.

NPL 2: N. Peach, “Bearings-only tracking using a set of range-parameterised extended Kalman filters,” IEE Proceedings-Control Theory and Applications, vol. 142, pages 73-80, 1995.

### SUMMARY OF INVENTION

### Technical Problem

In particular, a moving body that moves underwater or in similar environments where GPS (Global Positioning System) cannot be used estimates its own position using a self-position estimation device. However, as time passes, the error in self-position estimation accumulates. Therefore, when the waiting time during turning is long, there is a risk that the follower moving body will deviate from the merging point due to the error in self-position estimation.

In order to enable successful merging even when the follower moving body is distant from the merging point, a method is required to accomplish the merging of moving bodies scattered over a wide area. Non patent literature 1 and 2 do not describe a method for achieving the merging of moving bodies scattered over a wider area.

One example objective of the present disclosure is to provide a moving body control system, a moving body control method, a leader moving body, a leader moving body control method, a follower moving body, a follower moving body control method, and a recording medium that can achieve the merging of moving bodies scattered over a wide area.

### Solution to Problem

To achieve the above objective, a moving body control system according to one aspect of the present disclosure is a moving body control system that includes a leader moving body and a follower moving body, wherein the leader moving body includes a leader preliminary agreement unit that shares, with the follower moving body prior to merging of the leader moving body and the follower moving body, an agreement item that is an item agreed upon regarding a method by which the leader moving body and the follower moving body merge and a leader movement control unit that controls movement of the leader moving body based on the shared agreement item, and the follower moving body includes a follower preliminary agreement unit that shares the agreement item with the leader moving body prior to merging of the leader moving body and the follower moving body and a follower movement control unit that controls movement of the follower moving body based on the shared agreement item.

To achieve the above objective, a moving body control method according to another aspect of the present disclosure is a moving body control method executed in a moving body control system including a leader moving body and a follower moving body, the method including sharing, by the leader moving body with the follower moving body prior to merging of the leader moving body and the follower moving body, an agreement item that is an item agreed upon regarding a method by which the leader moving body and the follower moving body merge, controlling, by the leader moving body, movement of the leader moving body based on the shared agreement item, sharing, by the follower moving body with the leader moving body prior to merging of the leader moving body and the follower moving body, the agreement item, and controlling, by the follower moving body, movement of the follower moving body based on the shared agreement item.

To achieve the above objective, a leader moving body according to another aspect of the present disclosure includes a leader preliminary agreement unit that shares an agreement item, which is an item agreed upon regarding a method of merging the leader moving body and the follower moving body, with the follower moving body prior to merging, a leader movement control unit that controls movement of the leader moving body based on the shared agreement item, and a transmission unit that transmits a signal indicating a call for merging to the follower moving body.

To achieve the above objective, a leader moving body control method according to another aspect of the present disclosure includes sharing an agreement item, which is an item agreed upon regarding a method of merging the leader moving body and the follower moving body, with the follower moving body prior to merging, controlling movement of the leader moving body based on the shared agreement item, and transmitting a signal indicating a call for merging to the follower moving body.

To achieve the above objective, a non-transitory leader moving body-readable recording medium storing a leader moving body control program according to another aspect of the present disclosure stores a leader moving body control program which, when executed by a leader moving body, causes the leader moving body to perform processing including sharing an agreement item, which is an item agreed upon regarding a method of merging the leader moving body and the follower moving body, with the follower moving body prior to merging, controlling movement of the leader moving body based on the shared agreement item, and transmitting a signal indicating a call for merging to the follower moving body.

To achieve the above objective, a follower moving body according to another aspect of the present disclosure includes a follower preliminary agreement unit that shares an agreement item, which is an item agreed upon regarding the method of merging the leader moving body and the follower moving body, with the leader moving body prior to merging, a follower movement control unit that controls the movement of the follower moving body based on the shared agreement item, and a reception unit that receives a signal indicating a call for merging transmitted from the leader moving body.

To achieve the above objective, a follower moving body control method according to another aspect of the present disclosure includes sharing an agreement item, which is an item agreed upon regarding the method of merging the leader moving body and the follower moving body, with the leader moving body prior to merging, controlling the movement of the follower moving body based on the shared agreement item, and receiving a signal indicating a call for merging transmitted from the leader moving body.

To achieve the above objective, a non-transitory follower moving body-readable recording medium storing a follower moving body control program according to another aspect of the present disclosure stores a follower moving body control program which, when executed by a follower moving body, causes the follower moving body to perform processing including sharing an agreement item, which is an item agreed upon regarding the method of merging the leader moving body and the follower moving body, with the leader moving body prior to merging, controlling the movement of the follower moving body based on the shared agreement item, and receiving a signal indicating a call for merging transmitted from the leader moving body.

### Advantageous Effects of Invention

According to the present disclosure, it is possible to achieve the merging of moving bodies scattered over a wide area.

### BRIEF DESCRIPTION OF DRAWINGS

FIG. 1 It is a block diagram showing an example configuration of a moving body control system according to an example embodiment of the present invention.

FIG. 2 It is an explanatory diagram showing an example of agreement items related to the merging method shared between the leader preliminary agreement unit 110 and the follower preliminary agreement unit 210.

FIG. 3 It is a flowchart showing an operation of a movement process by the leader moving body 100 in the present example embodiment.

FIG. 4 It is a flowchart showing an operation of a movement process by the follower moving body 200 in the present example embodiment.

FIG. 5 It is an explanatory diagram showing an example hardware configuration of the leader moving body 100 according to the present invention.

FIG. 6 It is an explanatory diagram showing an example hardware configuration of the follower moving body 200 according to the present invention.

FIG. 7 It is a block diagram showing an overview of the moving body control system according to the present invention.

FIG. 8 It is a block diagram showing an overview of the leader moving body according to the present invention.

FIG. 9 It is a block diagram showing an overview of the follower moving body according to the present invention.

### EXAMPLE EMBODIMENT

Hereinafter, example embodiments of the present invention will be explained with reference to the drawings. In the drawings explained below, components having the same function or a function related to it are assigned the same reference numerals. In some cases, descriptions of the same or related functions that would be repetitive may be omitted.

### [Explanation of Configuration]

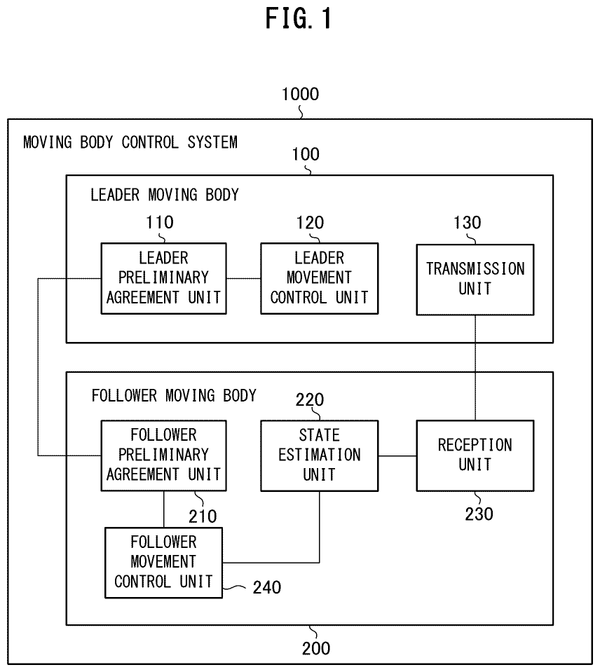

FIG. 1 is a block diagram showing an example configuration of a moving body control system according to an example embodiment of the present invention. A moving body control system 1000 shown in FIG. 1 includes a leader moving body 100 and a follower moving body 200.

The leader moving body 100 and the follower moving body 200 are, for example, unmanned undersea vehicles (UUVs). Note that the moving body control system 1000 may include two or more follower moving bodies 200.

The leader moving body 100 shown in FIG. 1 includes a leader preliminary agreement unit 110, a leader movement control unit 120, and a transmission unit 130. The follower moving body 200 shown in FIG. 1 includes a follower preliminary agreement unit 210, a state estimation unit 220, a reception unit 230, and a follower movement control unit 240.

The transmission unit 130 is a component included in the leader moving body 100. The transmission unit 130 issues a call for merging to the follower using a signal with a communication frequency capable of wide-area communication.

In general, the lower the communication frequency, the longer the communication range becomes. Also, the lower the communication frequency, the smaller the amount of information that can be transmitted.

To maximize the communication range, the transmission unit 130 communicates using a signal with a low-frequency communication frequency that does not contain information such as coordinates.

The reception unit 230 is a component included in the follower moving body 200. The reception unit 230 receives a signal transmitted from the transmission unit 130. Then, the reception unit 230 detects the direction of the leader moving body 100 that transmitted the signal.

The signal transmitted by the transmission unit 130 may not include information such as coordinates indicating the position of the leader moving body 100. A situation in which the reception unit 230 receives a signal that does not include information such as coordinates is, for example, similar to a case where a person can recognize that a voice was called out from the right side but cannot understand the content of the speech.

The leader preliminary agreement unit 110 is a component included in the leader moving body 100. The follower preliminary agreement unit 210 is a component included in the follower moving body 200.

The leader preliminary agreement unit 110 and the follower preliminary agreement unit 210 share an agreement item, which is an item agreed upon regarding the method of merging, prior to the merging of the leader moving body 100 and the follower moving body 200. The timing before merging is, for example, before departure. The contents to be shared include merging waiting location, merging time, merging point, movement direction at the time of merging, speed at the time of merging, and communication bandwidth at the time of merging.

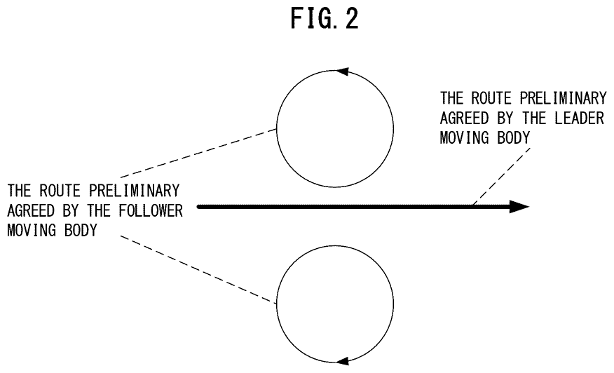

FIG. 2 is an explanatory diagram showing an example of agreement items related to the merging method shared between the leader preliminary agreement unit 110 and the follower preliminary agreement unit 210. In the example shown in FIG. 2, the two follower moving bodies 200 each assume a circle with a radius of 4 centered at coordinates (0,10) and (0,-10), respectively, as the merging waiting point.

In the example shown in FIG. 2, the leader moving body 100 starts merging action from the merging point (−10,0) in accordance with the merging time 12:00. The movement direction at the time of merging is parallel to the X-axis direction (the direction of vector (1,0)). The speed at the time of merging is 2 (m/s). The communication bandwidth at the time of merging is 10 (kHz).

The leader movement control unit 120 is a component included in the leader moving body 100. The leader movement control unit 120 controls the movement of the leader moving body 100 in such a way as to merge with the follower moving body 200 in accordance with the agreement items agreed upon in advance by the leader preliminary agreement unit 110.

Specifically, the leader movement control unit 120 controls the movement of the leader moving body 100 in such a way as to arrive at the merging point at the merging time and move from the merging point in the movement direction at the time of merging at the speed at the time of merging.

In addition, until the leader moving body 100 moves to the merging point, the transmission unit 130 issues multiple calls for merging to the follower using a signal with a communication frequency for the communication bandwidth at the time of merging.

The state estimation unit 220 is a component included in the follower moving body 200. The state estimation unit 220 estimates the state of the leader moving body 100 based on the direction of the leader detected by the reception unit 230 and the contents shared by the follower preliminary agreement unit 210.

The state of the leader moving body 100 includes, for example, the relative coordinates, relative movement direction, and relative movement speed as seen from the follower.

When estimating the state using time-series data representing only direction, the state estimation unit 220 may use any method. In particular, the extended Kalman filter described in non patent literature 2 is a well-known method capable of estimating the state.

However, the accuracy of the state estimated using time-series data representing only direction is often low. The main reason for this low accuracy is that filter-based methods such as the extended Kalman filter strongly depend on the initial value.

When a method using a filter is employed, it is expected that by providing a rough initial value, the initial value will be corrected each time observational data is input, and gradually converge to the true value.

However, when estimating the state using time-series data representing only direction, there are many variables to be calculated from the time-series data representing only direction. The variables include, for example, coordinates, movement direction, and movement speed. Therefore, when the initial value is far from the true value, the initial value may not converge to the true value even when the method using a filter is used.

Therefore, the state estimation unit 220 determines the initial value to be given to the filter based on the agreement items agreed upon in advance by the follower preliminary agreement unit 210. That is, the state estimation unit 220 sets the initial values such as the coordinates, movement direction, and movement speed of the leader moving body 100 shared by the leader preliminary agreement unit 110 and the follower preliminary agreement unit 210.

The coordinates of the leader moving body 100 may deviate from the true value due to self-position estimation error. However, the movement direction of the leader moving body 100, which can be measured with high accuracy using a compass or similar device, and the movement speed of the leader moving body 100, which is controlled by the leader movement control unit 120 to match the shared content, are expected to be close to the true values.

That is, by using the agreement items agreed upon in advance, the initial value can be set close to the true value, and the state estimation unit 220 can estimate the state with higher accuracy.

In addition, the agreement items agreed upon in advance may also be used for purposes other than initial values. For example, the extended Kalman filter includes at least the three variables required by the state estimation unit 220: coordinates, movement direction, and movement speed.

Therefore, the state estimation unit 220 may fix the movement direction and movement speed as constants based on the agreement items for the three variables in the extended Kalman filter. The state estimation unit 220 can improve the accuracy of the estimated state by using the agreement items for various other state estimation methods as well.

The follower movement control unit 240 is a component included in the follower moving body 200. The follower movement control unit 240 controls the movement of the follower moving body 200 in such a way as to follow the leader moving body 100 in accordance with the agreement items agreed upon in advance by the follower preliminary agreement unit 210.

In addition, after the relative coordinates, movement direction, and movement speed of the leader moving body 100 are estimated, the follower movement control unit 240 controls the movement direction and movement speed of the follower moving body 200 to enable it to follow the leader moving body 100. That is, the follower movement control unit 240 controls the movement of the follower moving body 200 based on the state of the leader moving body 100 estimated by the state estimation unit 220.

When the movement direction and movement speed are controlled in such a way that the follower moving body 200 can follow the leader moving body 100, the follower moving body 200 gradually approaches the leader moving body 100. Eventually, the follower moving body 200 comes to follow the leader moving body 100.

As described above, the leader moving body 100 according to the present example embodiment includes a leader preliminary agreement unit 110 that shares the agreement items, which are items agreed upon regarding the method of merging the leader moving body 100 and the follower moving body 200, with the follower moving body 200 prior to merging, a leader movement control unit 120 that controls the movement of the leader moving body 100 based on the shared agreement items, and a transmission unit 130 that transmits a signal indicating a call for merging to the follower moving body 200.

The transmission unit 130 may transmit the signal multiple times to the follower moving body 200 prior to the merging of the leader moving body 100 and the follower moving body 200.

In addition, the follower moving body 200 according to the present example embodiment includes a follower preliminary agreement unit 210 that shares the agreement items, which are items agreed upon regarding the method of merging the leader moving body 100 and the follower moving body 200, with the leader moving body 100 prior to merging, a follower movement control unit 240 that controls the movement of the follower moving body 200 based on the shared agreement items, and a reception unit 230 that receives a signal indicating a call for merging transmitted from the leader moving body 100.

The reception unit 230 detects the direction of the leader moving body 100 based on the received signal. The follower moving body 200 also includes a state estimation unit 220 that estimates the state of the leader moving body 100 based on the detected direction and the shared agreement items.

Therefore, the leader moving body 100 and the follower moving body 200 according to the present example embodiment can merge by following the agreement items agreed upon in advance, even when using a low-frequency communication frequency for long-distance communication that cannot transmit position information.

### [Explanation of Operation]

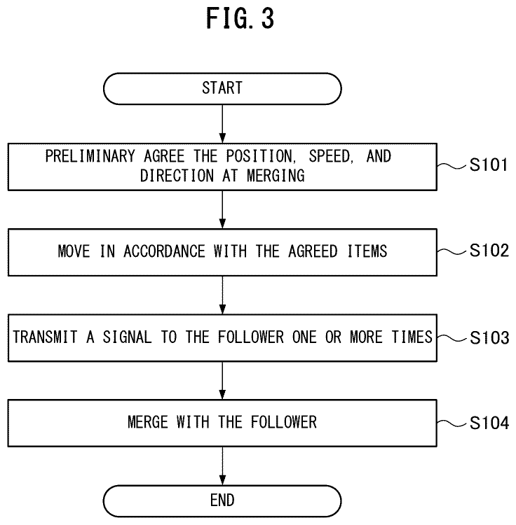

The operation of the leader moving body 100 according to the present example embodiment will be explained below with reference to FIG. 3. FIG. 3 is a flowchart showing the operation of the movement process by the leader moving body 100 in the present example embodiment.

First, the leader preliminary agreement unit 110 agrees in advance with the follower preliminary agreement unit 210 on the position, speed, and direction at the time of merging, which are items related to the merging of the leader moving body 100 and the follower moving body 200 (step S101).

Next, the leader movement control unit 120 moves the leader moving body 100 in accordance with the agreement items agreed upon in advance (step S102). That is, the leader movement control unit 120 aims to merge with the follower.

During movement, the transmission unit 130 transmits a signal indicating a call for merging to the follower moving body 200 one or more times based on the agreement items agreed upon in advance (step S103).

Finally, the leader moving body 100 merges with the follower moving body 200 (step S104). After merging, the leader moving body 100 terminates the movement process.

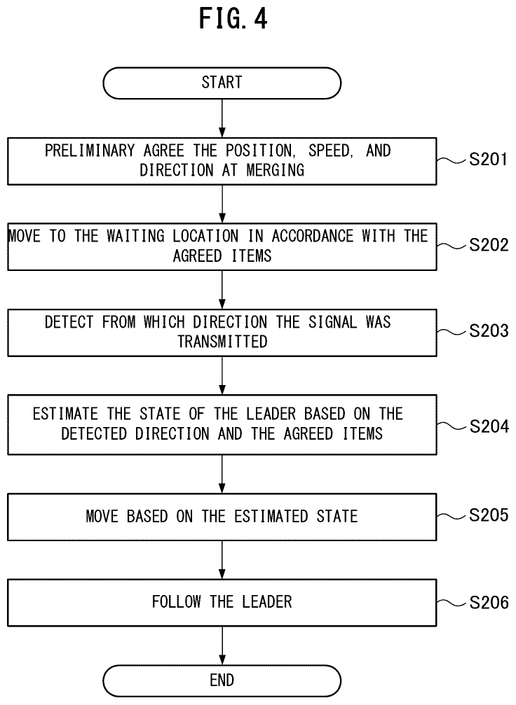

Next, the operation of the follower moving body 200 according to the present example embodiment will be explained with reference to FIG. 4. FIG. 4 is a flowchart showing the operation of the movement process by the follower moving body 200 in the present example embodiment.

First, the follower preliminary agreement unit 210 agrees in advance with the leader preliminary agreement unit 110 on the position, speed, and direction at the time of merging, which are items related to the merging of the leader moving body 100 and the follower moving body 200 (step S201).

Next, the follower moving body 200 moves to the waiting location based on the agreement items agreed upon in advance (step S202). For example, the follower moving body 200 performs turning standby at the waiting location.

Next, the reception unit 230 receives the signal transmitted by the transmission unit 130 in step S103. Then, the reception unit 230 detects the direction from which the signal was transmitted (step S203). That is, the reception unit 230 detects the direction of the leader moving body 100 that transmitted the signal.

Next, the state estimation unit 220 estimates the state of the leader moving body 100 based on the direction of the leader moving body 100 detected multiple times and the agreement items agreed upon in advance (step S204).

Next, the follower movement control unit 240 moves the follower moving body 200 in such a way as to follow the leader moving body 100 based on the estimated state of the leader moving body 100 (step S205).

Finally, the follower moving body 200 comes to follow the leader moving body 100 (step S206). After following, the follower moving body 200 terminates the movement process.

As described above, the moving body control system 1000 of the present example embodiment includes the leader moving body 100 and the follower moving body 200.

The leader moving body 100 includes the leader preliminary agreement unit 110 that shares the agreement items, which are items agreed upon regarding the method of merging the leader moving body 100 and the follower moving body 200, with the follower moving body 200 prior to merging, and the leader movement control unit 120 that controls the movement of the leader moving body 100 based on the shared agreement items.

The follower moving body 200 includes the follower preliminary agreement unit 210 that shares the agreement items with the leader moving body 100 prior to merging, and the follower movement control unit 240 that controls the movement of the follower moving body 200 based on the shared agreement items.

The leader moving body 100 includes the transmission unit 130 that transmits a signal indicating a call for merging to the follower moving body 200.

The follower moving body 200 includes the reception unit 230 that receives the transmitted signal. The reception unit 230 detects the direction of the leader moving body 100 based on the received signal.

The follower moving body 200 includes the state estimation unit 220 that estimates the state of the leader moving body 100 based on the detected direction and the shared agreement items. The follower movement control unit 240 controls the movement of the follower moving body 200 based on the estimated state.

The state estimation unit 220 estimates the state using, for example, an extended Kalman filter. The state estimation unit 220 may determine the initial value of the state based on the shared agreement items.

### [Explanation of Effects]

The leader preliminary agreement unit 110 and the follower preliminary agreement unit 210 of the present example embodiment share in advance the agreement items regarding the method for merging the leader moving body 100 and the follower moving body 200.

Therefore, since a communication frequency for long-distance communication that cannot transmit position information can be used, the moving body control system 1000 of the present example embodiment can achieve the merging of moving bodies scattered over a wide area.

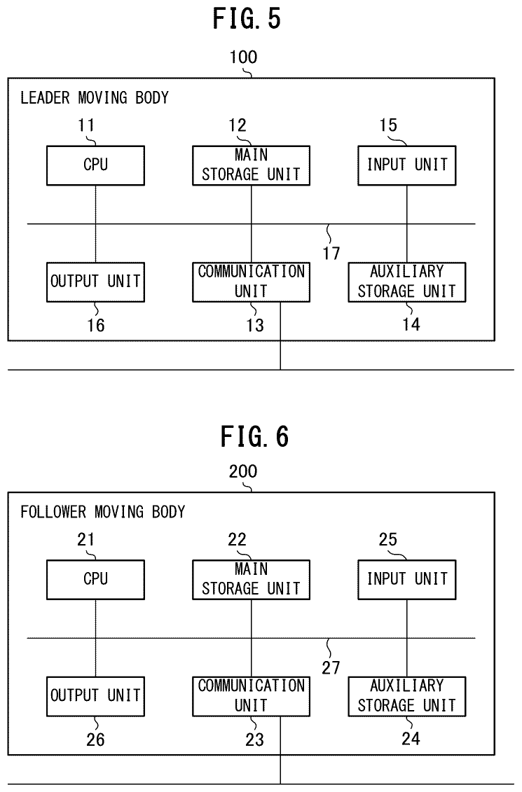

The specific example of the hardware configuration of the leader moving body 100 of the present example embodiment will be explained below. FIG. 5 is an explanatory diagram showing an example hardware configuration of the leader moving body 100 according to the present invention.

The leader moving body 100 shown in FIG. 5 includes a CPU (Central Processing Unit) 11, a main storage unit 12, a communication unit 13, and an auxiliary storage unit 14. It also includes an input unit 15 for user operation and an output unit 16 for presenting the processing results or the progress of processing to the user.

The leader moving body 100 is implemented in software by the CPU 11 shown in FIG. 5 executing a program that provides the functions of each component.

That is, the CPU 11 loads the program stored in the auxiliary storage unit 14 into the main storage unit 12 and executes it to control operation of the leader moving body 100. This enables each function by software.

Note that the leader moving body 100 shown in FIG. 5 may include a DSP (Digital Signal Processor) instead of the CPU 11. Alternatively, the leader moving body 100 shown in FIG. 5 may include both the CPU 11 and the DSP.

The main storage unit 12 is used as a work area for data or a temporary storage area for data. The main storage unit 12 is, for example, a RAM (Random Access Memory).

The communication unit 13 has the function of inputting and outputting data to and from peripheral devices via a wireless network (information communication network).

The auxiliary storage unit 14 is a non-transitory tangible storage medium. Examples of non-transitory tangible storage media include magnetic disks, magneto-optical disks, CD-ROM (Compact Disk Read Only Memory), DVD-ROM (Digital Versatile Disk Read Only Memory), and semiconductor memory.

The input unit 15 has the function of inputting data or processing commands. The input unit 15 is, for example, an input device such as a keyboard or a mouse.

The output unit 16 has the function of outputting data. The output unit 16 is, for example, a display device such as a liquid crystal display device or a printing device such as a printer.

As shown in FIG. 5, each component of the leader moving body 100 is connected to a system bus 17.

The auxiliary storage unit 14 stores a program for implementing the leader preliminary agreement unit 110, the leader movement control unit 120, and the transmission unit 130 in the leader moving body 100.

Note that the leader moving body 100 may have a circuit that includes hardware components such as LSI (Large Scale Integration) to implement the functions shown in FIG. 1.

Next, a specific example of the hardware configuration of the follower moving body 200 of the present example embodiment will be explained. FIG. 6 is an explanatory diagram showing an example hardware configuration of the follower moving body 200 according to the present invention.

The follower moving body 200 shown in FIG. 6 includes a CPU 21, a main storage unit 22, a communication unit 23, and an auxiliary storage unit 24. It also includes an input unit 25 for user operation and an output unit 26 for presenting the processing results or the progress of processing to the user.

The follower moving body 200 is implemented in software by the CPU 21 shown in FIG. 6 executing a program that provides the functions of each component.

That is, the CPU 21 loads the program stored in the auxiliary storage unit 24 into the main storage unit 22 and executes it to control operation of the follower moving body 200. This enables each function by software.

Note that the follower moving body 200 shown in FIG. 6 may include a DSP instead of the CPU 21. Alternatively, the follower moving body 200 shown in FIG. 6 may include both the CPU 21 and the DSP.

The main storage unit 22 is used as a work area for data or a temporary storage area for data. The main storage unit 22 is, for example, a RAM.

The communication unit 23 has the function of inputting and outputting data to and from peripheral devices via a wireless network (information communication network).

The auxiliary storage unit 24 is a non-transitory tangible storage medium. Examples of non-transitory tangible storage media include magnetic disks, magneto-optical disks, CD-ROM, DVD-ROM, and semiconductor memory.

The input unit 25 has the function of inputting data or processing commands. The input unit 25 is, for example, an input device such as a keyboard or a mouse.

The output unit 26 has the function of outputting data. The output unit 26 is, for example, a display device such as a liquid crystal display device or a printing device such as a printer.

As shown in FIG. 6, each component of the follower moving body 200 is connected to a system bus 27.

In the follower moving body 200, the auxiliary storage unit 24 stores programs for implementing the follower preliminary agreement unit 210, the state estimation unit 220, the reception unit 230, and the follower movement control unit 240.

Note that the follower moving body 200 may include a circuit having hardware components such as an LSI to implement the functions shown in FIG. 1.

The leader moving body 100 and the follower moving body 200 may also be implemented by hardware that does not include computer functions using elements such as CPUs. For example, some or all of the components may be implemented by general-purpose circuitry, dedicated circuitry, a processor, or a combination thereof. These may be configured as a single chip (for example, the above-mentioned LSI), or as multiple chips connected via a bus. Some or all of the components may also be implemented by a combination of the above-described circuitry and a program.

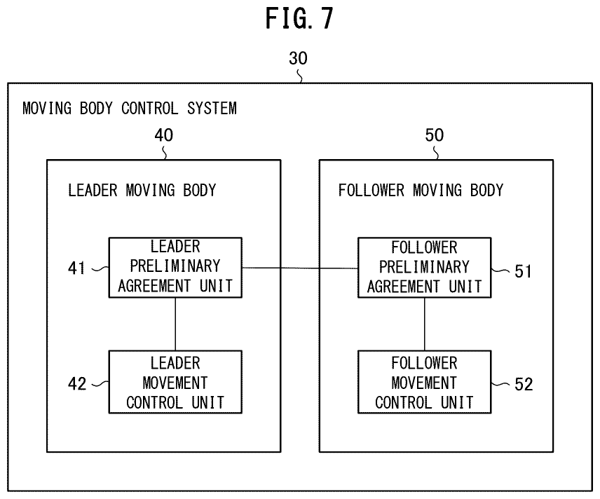

Next, the overview of the present invention will be explained. FIG. 7 is a block diagram showing an overview of the moving body control system according to the present invention. A moving body control system 30 according to the present invention is a moving body control system including a leader moving body 40 (for example, the leader moving body 100) and a follower moving body 50 (for example, the follower moving body 200). The leader moving body 40 includes a leader preliminary agreement unit 41 (for example, the leader preliminary agreement unit 110) that shares an agreement item, which is an item agreed upon regarding the method of merging the leader moving body 40 and the follower moving body 50, with the follower moving body 50 prior to merging, and a leader movement control unit 42 (for example, the leader movement control unit 120) that controls the movement of the leader moving body 40 based on the shared agreement item. The follower moving body 50 includes a follower preliminary agreement unit 51 (for example, the follower preliminary agreement unit 210) that shares the agreement item with the leader moving body 40 prior to merging, and a follower movement control unit 52 (for example, the follower movement control unit 240) that controls the movement of the follower moving body 50 based on the shared agreement item.

With such a configuration, the moving body control system can achieve the merging of moving bodies scattered over a wide area.

The leader moving body 40 may further include a transmission unit (for example, the transmission unit 130) that transmits a signal indicating a call for merging to the follower moving body 50.

The follower moving body 50 may include a reception unit (for example, the reception unit 230) that receives the transmitted signal, and the reception unit may detect the direction of the leader moving body 40 based on the received signal.

With such a configuration, the moving body control system can more easily allow the follower moving body to follow the leader moving body.

The follower moving body 50 may include a state estimation unit (for example, the state estimation unit 220) that estimates the state of the leader moving body 40 based on the detected direction of the leader moving body 40 and the shared agreement item, and the follower movement control unit 52 may control the movement of the follower moving body 50 based on the estimated state. The state estimation unit may estimate the state using an extended Kalman filter.

With such a configuration, the moving body control system can more easily allow the follower moving body to follow the leader moving body.

The state estimation unit may determine the initial value of the state based on the shared agreement item.

With such a configuration, the moving body control system can estimate the state of the leader moving body with high accuracy.

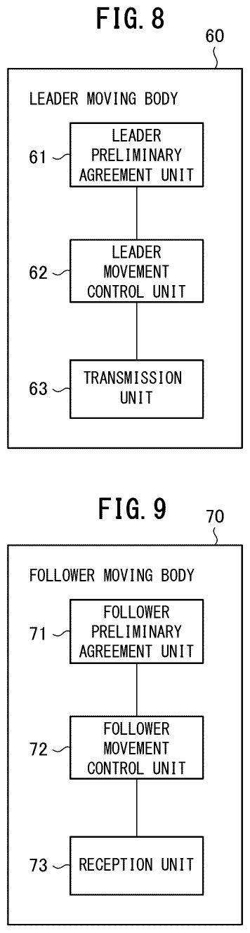

FIG. 8 is a block diagram showing an overview of the leader moving body according to the present invention. A leader moving body 60 according to the present invention includes a leader preliminary agreement unit 61 (for example, the leader preliminary agreement unit 110) that shares an agreement item, which is an item agreed upon regarding the method of merging the leader moving body 60 and the follower moving body, with the follower moving body prior to merging, a leader movement control unit 62 (for example, the leader movement control unit 120) that controls the movement of the leader moving body 60 based on the shared agreement item, and a transmission unit 63 (for example, the transmission unit 130) that transmits a signal indicating a call for merging to the follower moving body.

With such a configuration, the leader moving body can achieve the merging of moving bodies scattered over a wide area.

The transmission unit 63 may transmit the signal to the follower moving body multiple times prior to merging of the leader moving body 60 and the follower moving body.

FIG. 9 is a block diagram showing an overview of the follower moving body according to the present invention. A follower moving body 70 according to the present invention includes a follower preliminary agreement unit 71 (for example, the follower preliminary agreement unit 210) that shares an agreement item, which is an item agreed upon regarding the method of merging the leader moving body and the follower moving body 70, with the leader moving body prior to merging, a follower movement control unit 72 (for example, the follower movement control unit 240) that controls the movement of the follower moving body 70 based on the shared agreement item, and a reception unit 73 (for example, the reception unit 230) that receives a signal indicating a call for merging transmitted from the leader moving body.

With such a configuration, the follower moving body can achieve the merging of moving bodies scattered over a wide area.

The reception unit 73 may detect the direction of the leader moving body based on the received signal.

Some or all of the above-described example embodiments may also be described as the following appended forms, but are not limited thereto.

### (Supplementary Note 1)

A moving body control system comprising:
a leader moving body; and
a follower moving body,
wherein the leader moving body comprises:
a leader preliminary agreement unit that shares, with the follower moving body prior to merging of the leader moving body and the follower moving body, an agreement item that is an item agreed upon regarding a method by which the leader moving body and the follower moving body merge; and
a leader movement control unit that controls movement of the leader moving body based on the shared agreement item, and
wherein the follower moving body comprises:
a follower preliminary agreement unit that shares the agreement item with the leader moving body prior to merging of the leader moving body and the follower moving body; and
a follower movement control unit that controls movement of the follower moving body based on the shared agreement item.

### (Supplementary Note 2)

The moving body control system according to Supplementary Note 1, wherein
the leader moving body further comprises a transmission unit that transmits a signal indicating a call for merging to the follower moving body.

### (Supplementary Note 3)

The moving body control system according to Supplementary Note 2, wherein
the follower moving body further comprises a reception unit that receives the transmitted signal, and
the reception unit detects a direction of the leader moving body based on the received signal.

### (Supplementary Note 4)

The moving body control system according to Supplementary Note 3, wherein
the follower moving body further comprises a state estimation unit that estimates a state of the leader moving body based on the detected direction of the leader moving body and the shared agreement item, and
the follower movement control unit controls movement of the follower moving body based on the estimated state.

### (Supplementary Note 5)

The moving body control system according to Supplementary Note 4, wherein the state estimation unit estimates the state using an extended Kalman filter.

### (Supplementary Note 6)

The moving body control system according to Supplementary Note 4 or Supplementary Note 5, wherein
the state estimation unit determines an initial value of the state based on the shared agreement item.

### (Supplementary Note 7)

A moving body control method executed in a moving body control system including a leader moving body and a follower moving body, the method comprising:
sharing, by the leader moving body with the follower moving body prior to merging of the leader moving body and the follower moving body, an agreement item that is an item agreed upon regarding a method by which the leader moving body and the follower moving body merge;
controlling, by the leader moving body, movement of the leader moving body based on the shared agreement item;
sharing, by the follower moving body with the leader moving body prior to merging of the leader moving body and the follower moving body, the agreement item; and
controlling, by the follower moving body, movement of the follower moving body based on the shared agreement item.

### (Supplementary Note 8)

The moving body control method according to Supplementary Note 7, further comprising:
transmitting, by the leader moving body, a signal indicating a call for merging to the follower moving body.

### (Supplementary Note 9)

The moving body control method according to Supplementary Note 8, further comprising:
receiving, by the follower moving body, the transmitted signal; and
detecting, by the follower moving body, a direction of the leader moving body based on the received signal.

### (Supplementary Note 10)

The moving body control method according to Supplementary Note 9, further comprising:
estimating, by the follower moving body, a state of the leader moving body based on the detected direction of the leader moving body and the shared agreement item; and
controlling, by the follower moving body, movement of the follower moving body based on the estimated state.

### (Supplementary Note 11)

The moving body control method according to Supplementary Note 10, wherein
estimating, by the follower moving body, the state using an extended Kalman filter.

### (Supplementary Note 12)

The moving body control method according to Supplementary Note 10 or Supplementary Note 11, further comprising:
determining, by the follower moving body, an initial value of the state based on the shared agreement item.

### (Supplementary Note 13)

A leader moving body comprising:
a leader preliminary agreement unit that shares, with a follower moving body prior to merging of the leader moving body and the follower moving body, an agreement item that is an item agreed upon regarding a method by which the leader moving body and the follower moving body merge;
a leader movement control unit that controls movement of the leader moving body based on the shared agreement item; and
a transmission unit that transmits a signal indicating a call for merging to the follower moving body.

### (Supplementary Note 14)

The leader moving body according to Supplementary Note 13, wherein
the transmission unit transmits the signal to the follower moving body multiple times prior to merging of the leader moving body and the follower moving body.

### (Supplementary Note 15)

A leader moving body control method comprising:
sharing, with a follower moving body prior to merging of the leader moving body and the follower moving body, an agreement item that is an item agreed upon regarding the method by which the leader moving body and the follower moving body merge;
controlling movement of the leader moving body based on the shared agreement item; and
transmitting a signal indicating a call for merging to the follower moving body.

### (Supplementary Note 16)

A leader moving body-readable recording medium storing a leader moving body control program which, when executed on a leader moving body, causes the leader moving body to perform processing comprising:
sharing, with a follower moving body prior to merging of the leader moving body and the follower moving body, an agreement item that is an item agreed upon regarding the method by which the leader moving body and the follower moving body merge;
controlling movement of the leader moving body based on the shared agreement item; and
transmitting a signal indicating a call for merging to the follower moving body.

### (Supplementary Note 17)

A leader moving body control program for causing a leader moving body to execute:
a sharing process that shares, with a follower moving body prior to merging of the leader moving body and the follower moving body, an agreement item that is an item agreed upon regarding the method by which the leader moving body and the follower moving body merge;
a control process that controls movement of the leader moving body based on the shared agreement item; and
a transmission process that transmits a signal indicating a call for merging to the follower moving body.

### (Supplementary Note 18)

A follower moving body comprising:
a follower preliminary agreement unit that shares, with a leader moving body prior to merging of the leader moving body and the follower moving body, an agreement item that is an item agreed upon regarding a method by which the leader moving body and the follower moving body merge;
a follower movement control unit that controls movement of the follower moving body based on the shared agreement item; and
a reception unit that receives a signal indicating a call for merging transmitted from the leader moving body.

### (Supplementary Note 19)

The follower moving body according to Supplementary Note 18, wherein
the reception unit detects a direction of the leader moving body based on the received

### (Supplementary Note 20)

A follower moving body control method comprising:
sharing, with a leader moving body prior to merging of the leader moving body and the follower moving body, an agreement item that is an item agreed upon regarding the method by which the leader moving body and the follower moving body merge;
controlling movement of the follower moving body based on the shared agreement item; and
receiving a signal indicating a call for merging transmitted from the leader moving body.

### (Supplementary Note 21)

A follower moving body-readable recording medium storing a follower moving body control program which, when executed by a follower moving body, causes the follower moving body to perform processing comprising:
sharing, with a leader moving body prior to merging of the leader moving body and the follower moving body, an agreement item that is an item agreed upon regarding the method by which the leader moving body and the follower moving body merge;
controlling movement of the follower moving body based on the shared agreement item; and
receiving a signal indicating a call for merging transmitted from the leader moving body.

### (Supplementary Note 22)

A follower moving body control program for causing a follower moving body to execute:
a sharing process that shares, with a leader moving body prior to merging of the leader moving body and the follower moving body, an agreement item that is an item agreed upon regarding a method by which the leader moving body and the follower moving body merge;
a control process that controls movement of the follower moving body based on the shared agreement item; and
a reception process that receives a signal indicating a call for merging transmitted from the leader moving body.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

### REFERENCE SIGNS LIST

11,21 CPU
12, 22 Main storage unit
13, 23 Communication unit
14, 24 Auxiliary storage unit
15, 25 Input unit
16, 26 Output unit
17, 27 System bus
30, 1000 Moving body control system
40, 60, 100 Leader moving body
41,61, 110 Leader preliminary agreement unit
42, 62, 120 Leader movement control unit
50, 70, 200 Follower moving body
51, 71, 210 Follower preliminary agreement unit
52, 72, 240 Follower movement control unit
63, 130 Transmission unit
73, 230 Reception unit
220 State estimation unit

What is claimed is:

1. A moving body control system comprising:
a leader moving body; and
a follower moving body,
wherein the leader moving body comprises:
a first memory storing software instructions; and
one or more first processors configured to execute the software instructions to:
share, with the follower moving body prior to merging of the leader moving body and the follower moving body, an agreement item that is an item agreed upon regarding a method by which the leader moving body and the follower moving body merge; and
control movement of the leader moving body based on the shared agreement item, and
wherein the follower moving body comprises:
a second memory storing software instructions; and
one or more second processors configured to execute the software instructions to:
share the agreement item with the leader moving body prior to merging of the leader moving body and the follower moving body; and
control movement of the follower moving body based on the shared agreement item.

2. The moving body control system according to claim 1, wherein
the one or more first processors are further configured to execute the software instructions to transmit a signal indicating a call for merging to the follower moving body.

3. The moving body control system according to claim 2, wherein
the one or more second processors are further configured to execute the software instructions to:
receive the transmitted signal; and
detect a direction of the leader moving body based on the received signal.

4. The moving body control system according to claim 3, wherein
the one or more second processors are further configured to execute the software instructions to:
estimate a state of the leader moving body based on the detected direction of the leader moving body and the shared agreement item; and
control movement of the follower moving body based on the estimated state.

5. The moving body control system according to claim 4, wherein
the one or more second processors are further configured to execute the software instructions to
estimate the state using an extended Kalman filter.

6. The moving body control system according to claim 4, wherein
the one or more second processors are further configured to execute the software instructions to
determine an initial value of the state based on the shared agreement item.

7-12. (canceled)

13. A leader moving body comprising:
a memory storing software instructions; and
one or more processors configured to execute the software instructions to:
share, with a follower moving body prior to merging of the leader moving body and the follower moving body, an agreement item that is an item agreed upon regarding a method by which the leader moving body and the follower moving body merge;
control movement of the leader moving body based on the shared agreement item; and
transmit a signal indicating a call for merging to the follower moving body.

14. The leader moving body according to claim 13, wherein
the one or more processors are further configured to execute the software instructions to
transmit the signal multiple times to the follower moving body prior to merging.

15-16. (canceled)

17. A follower moving body comprising:
a memory storing software instructions; and
one or more processors configured to execute the software instructions to:
share, with a leader moving body prior to merging of the leader moving body and the follower moving body, an agreement item that is an item agreed upon regarding a method by which the leader moving body and the follower moving body merge;
control movement of the follower moving body based on the shared agreement item; and
receive a signal indicating a call for merging transmitted from the leader moving body.

18. The follower moving body according to claim 17, wherein
the one or more processors are further configured to execute the software instructions to
detect a direction of the leader moving body based on the received signal.

19-20. (canceled)
